(19) United States
(12) Patent Application Publication
(10) Pub. No.: US 2011/0122324 A1
(43) Pub. Date: May 26, 2011

(54) Display apparatus, method of driving the display device, and electronic device

(75) Inventors: Junichi Yamashita, Tokyo (JP); Katsuhide Uchino, Kanagawa (JP)

(73) Assignee: Sony Corporation, Tokyo (JP)

(21) Appl. No.: 12/926,069

(22) Filed: Oct. 25, 2010

(30) Foreign Application Priority Data
Nov. 24, 2009 (JP) 2009-266734

(51) Int. Cl. H04N 5/66; G09G 5/00

(52) U.S. Cl. 348/739; 345/211; 348/E05.133

(57) ABSTRACT

A display device, which may control start or stop of light emission of an organic EL element without increasing the number of elements, a method of driving the display device, and an electronic device having the display device are provided. The display device includes: a display section having sets of light emitting elements and pixel circuits arranged two-dimensionally; and a drive section driving each of the pixel circuits based on a video signal. The pixel circuit has a dual-gate first transistor having a first gate and a second gate and controlling electric current flowing into each of the light emitting elements, and a second transistor writing a signal voltage into the first gate in accordance with the video signal. The drive section applies voltage different between for starting light emission of the light emitting element and for stopping light emission of the light emitting element to the second gate.

### BACKGROUND OF THE INVENTION

1. Field of the Invention

The present invention relates to a display device that displays an image by light emitting elements disposed for respective pixels, a method of driving the display device, and an electronic device having the display device.

2. Description of Related Art

Recently, a display device using a current-drive optical element as a light emitting element of a pixel has been developed and commercialized in a field of display devices for image display, the optical element being changed in emission luminance in accordance with a value of electric current flowing into the optical element, for example, an organic EL (Electro Luminance) element.

The organic EL element is a self-luminous element unlike a liquid crystal element or the like. Therefore, a display device using the organic EL element (organic EL display device) does not need a light source (backlight), and therefore the device is high in image visibility, low in power consumption, and high in response speed compared with a liquid crystal display device that needs a light source.

A drive method of the organic EL display device includes simple (passive) matrix drive and active matrix drive as in the liquid crystal display device. The former has a difficulty that a large display with high resolution is hardly achieved while a simple device structure is given. Therefore, the active matrix drive is being actively developed at present. In the active matrix drive, electric current flowing into an organic EL element disposed for each pixel is controlled by an active element (typically TFT (Thin Film Transistor)) within a pixel circuit provided for each organic EL element.

Generally, a current-voltage (I-V) characteristic of the organic EL element degrades with time (temporal degradation). In the pixel circuit that current-drives the organic EL element, when the I-V characteristic of the organic EL element is changed with time, a voltage-dividing ratio between the organic EL element and TFT connected in series to the element is accordingly changed, resulting in change in gate-to-source voltage V_{gs} of the TFT. As a result, a value of current flowing into the TFT is changed, resulting in change in value of current flowing into the organic EL element, and consequently emission luminance is changed in accordance with the changed current value.

In TFT, threshold voltage Vₜₕ or mobility μ may be temporally changed, or may vary for each pixel circuit due to variation in manufacturing process. When the threshold voltage Vₜₕ or mobility μ of TFT varies for each pixel circuit, a value of current flowing into TFT varies for each pixel circuit. As a result, even if the same voltage is applied to respective gates of TFTs, emission luminance varies among organic EL elements, leading to loss of screen uniformity.

Thus, a measure to correct the threshold voltage Vₜₕ or mobility μ of TFT has been proposed so that even if the I-V characteristic of an organic EL element is changed with time, or the threshold voltage Vₜₕ, or mobility μ of TFT is changed with time, emission luminance of the organic EL element is kept constant without being affected by such temporal change (for example, see Japanese Unexamined Patent Application Publication No. 2008-083272).

### SUMMARY OF THE INVENTION

For example, a switching transistor is considered to be provided in the pixel circuit between an organic EL element and TFT connected in series to the organic EL element as a measure to control start or stop of light emission of the organic EL element. However, in such a case, pixel size is increased in correspondence to such an increased element, which is undesirably against a trend of high resolution. Therefore, it is desired to control start or stop of light emission of the organic EL element by other measures.

It is desirable to provide a display device, which may control start or stop of light emission of a light emitting element without increasing the number of elements within a pixel circuit, a method of driving the display device, and an electronic device using the display device.

A display device according to an embodiment of the invention includes a display section having sets of light emitting elements and pixel circuits arranged two-dimensionally, and a drive section driving each of the pixel circuits based on a video signal. The pixel circuit has two transistors (first transistor and second transistor). The first transistor is a dual-gate transistor including first and second gates, and controlling electric current flowing into each light emitting element. The second transistor writes a signal voltage into the first gate in accordance with the video signal. The drive section applies voltage to the second gate, the voltage being different between for starting light emission of the light emitting element and for stopping light emission of the light emitting element.

An electronic device according to an embodiment of the invention includes the above-mentioned display device.

A method of driving a display device according to an embodiment of the invention includes the following two steps:

(A) A step of preparing a display device having a configuration described below;

(B) A step of using a drive section to apply a first voltage to a second gate for stopping light emission of a light emitting element, and apply a second voltage different in magnitude from the first voltage to the second gate for starting light emission of the light emitting element.

The display device applied with the driving method includes a display section having sets of light emitting elements and pixel circuits arranged two-dimensionally, and a drive section driving each of the pixel circuits based on a video signal. The pixel circuit has two transistors (first transistor and second transistor). The first transistor is a dual-gate transistor including first and second gates, and controlling electric current flowing into each light emitting element. The second transistor writes a signal voltage into the first gate in accordance with the video signal.

In the display device, the method of driving the display device, and the electronic device according to the embodiments of the invention, the second gate is applied with voltage, the voltage being different between for starting light emission of the light emitting element and for stopping light emission of the light emitting element. Thus, electric current flowing into the light emitting element may be controlled.

According to the display device, the method of driving the display device, and the electronic device of the embodiments of the invention, the first transistor is configured of a dual-gate transistor, and a voltage applied to the second gate of the first transistor is controlled, thereby electric current flowing into the light emitting element may be controlled. Thus, start or stop of light emission of the light emitting element may be controlled without increasing the number of elements within a pixel circuit.

Other and further objects, features and advantages of the invention will appear more fully from the following description.

### BRIEF DESCRIPTION OF THE DRAWINGS

FIG. 1 is a block diagram showing an example of a display device according to a first embodiment of the invention.

FIG. 2 is a block diagram showing an example of an internal configuration of a pixel circuit array section in FIG. 1.

FIG. 3 is a waveform diagram for illustrating an example of operation of the display device of FIG. 1.

FIG. 4 is a relationship diagram between gate-source voltage V_{gs} and electric current I_{d} flowing into a light emitting element in the display device of FIG. 1.

FIG. 5 is a block diagram showing an example of a display device according to a second embodiment of the invention.

FIG. 6 is a block diagram showing an example of an internal configuration of a pixel circuit array section in FIG. 5.

FIG. 7 is a waveform diagram for illustrating an example of operation of the display device of FIG. 5.

FIG. 8 is a plan view showing a schematic configuration of a module including the display device according to each of the embodiments.

FIG. 9 is a perspective diagram showing appearance of application example 1 of the display device according to each of the embodiments.

FIGS. 10A and 10B are perspective diagrams, where FIG. 10A shows appearance of application example 2 as viewed from a surface side, and FIG. 10B shows appearance thereof as viewed from a back side.

FIG. 11 is a perspective diagram showing appearance of application example 3.

FIG. 12 is a perspective diagram showing appearance of application example 4.

FIGS. 13A to 13G are diagrams, where FIG. 13A is a front diagram of application example 5 in an opened state, FIG. 13B is a side diagram thereof, FIG. 13C is a front diagram thereof in a closed state, FIG. 13D is a left side diagram thereof, FIG. 13E is a right side diagram thereof, FIG. 13F is a top diagram thereof, and FIG. 13G is a bottom diagram thereof.

### DETAILED DESCRIPTION OF THE PREFERRED EMBODIMENTS

Hereinafter, preferred embodiments of the invention will be described in detail with reference to drawings. Description is made in the following sequence.

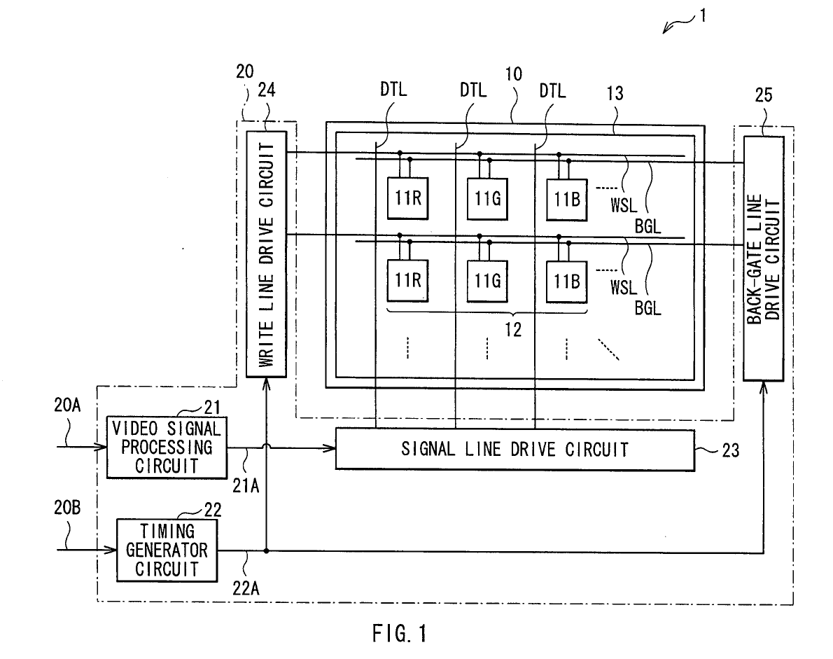

1. First embodiment (FIGS. 1 to 4)
Example of drive transistor as p-channel transistor

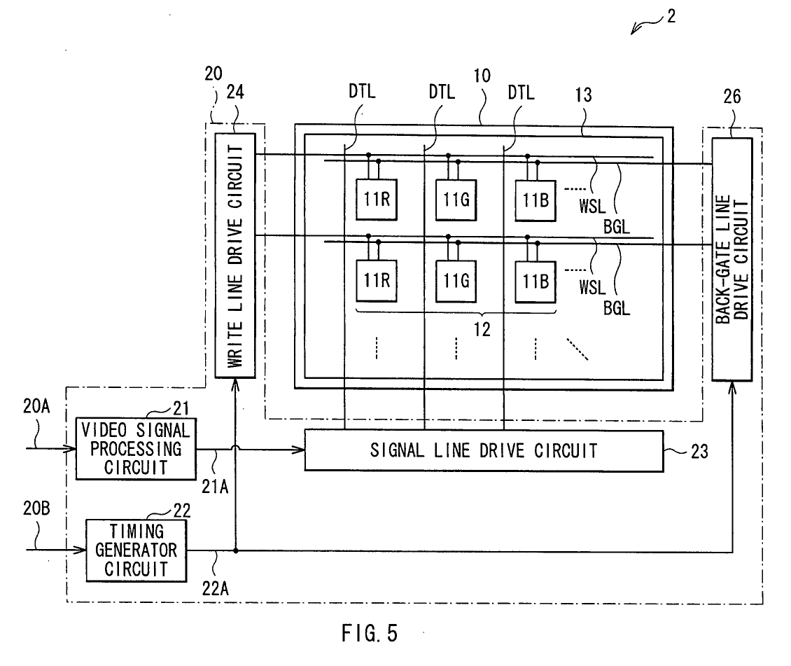

2. Second embodiment (FIGS. 5 to 7)
Example of drive transistor as n-channel transistor

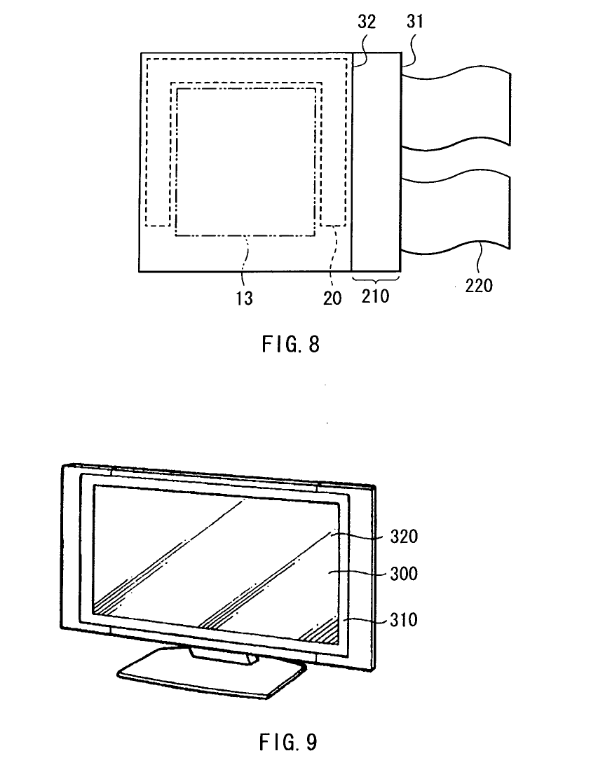

3. Module and application examples (FIGS. 8 to 13)

### First Embodiment

### Schematic Configuration of Display Device

FIG. 1 shows a schematic configuration of a display device 1 according to a first embodiment of the invention. The display device 1 includes a display panel 10 (display section) and a drive circuit 20 (drive section). The display panel 10 has, for example, a pixel circuit array section 13 having a plurality of organic EL elements 11R, 11G and 11B (light emitting elements) arranged two-dimensionally. In the embodiment, for example, three organic EL elements 11R, 11G and 11B adjacent to one another configure one pixel 12. Hereinafter, a term, organic EL element 11, is appropriately used as a general term of the organic EL elements 11R, 11G and 11B. The drive circuit 20 drives the pixel circuit array section 13, and, for example, has a video signal processing circuit 21, a timing generator circuit 22, a signal line drive circuit 23, a write line drive circuit 24 and a back-gate line drive circuit 25.

Pixel Circuit Array Section

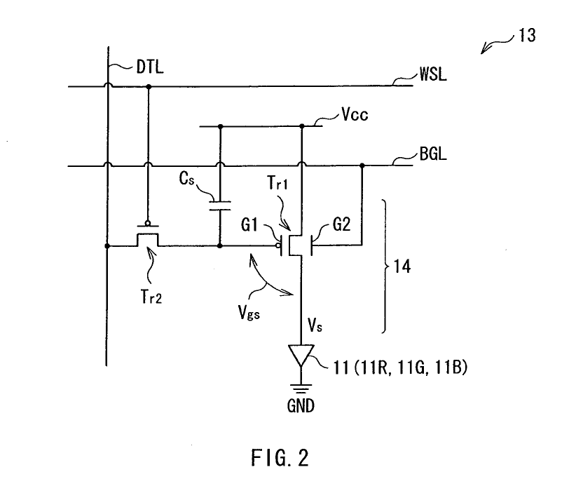

FIG. 2 shows an example of a circuit configuration of the pixel circuit array section 13. The pixel circuit array section 13 is formed in a display region of the display panel 10. The pixel circuit array section 13 has a plurality of write lines WSL disposed in rows, a plurality of signal lines DTL disposed in columns, and a plurality of back-gate lines BGL disposed in rows along the write lines WSL, for example, as shown in FIGS. 1 and 2. Sets of organic EL elements 11 and pixel circuits 14 are disposed in rows and columns (two-dimensionally) in correspondence to respective intersections of the write lines WSL and the signal lines DTL. Each pixel circuit 14 is configured of, for example, a drive transistor Tr₁ (first transistor), a write transistor Tr₂ (second transistor), and a capacitance Cₛ, and thus has a configuration of 2Tr1 C.

The drive transistor Tr₁ is formed of a dual-gate transistor having a top gate G1 (first gate) and a back gate G2 (second gate), and besides formed of a p-channel MOS thin-film transistor (TFT). The write transistor Tr₂ is formed of, for example, a dual-gate, top-gate, or bottom-gate transistor, and besides formed of a p-channel MOS TFT.

In the pixel circuit array section 13, each signal line DTL is connected to an output end (not shown) of the signal line drive circuit 23, and to a drain or source electrode (not shown) of the write transistor Tr₂. Each write line WSL is connected to an output end (not shown) of the write line drive circuit 24, and to a gate electrode (not shown) of the write transistor Tr₂. One of the drain and source electrodes of the write transistor Tr₂ (not shown), being not connected to the signal line DTL, is connected to a top gate electrode (not shown) of the drive transistor Tr₁ and to one end of the capacitance Cₛ. A drain or source electrode (not shown) of the drive transistor Tr₁ and the other end of the capacitance Cₛ are connected to a constant-voltage line Vcc. One of the drain and source electrodes of the drive transistor Tr₁ (not shown), being not connected to the constant-voltage line Vcc, is connected to an anode electrode (not shown) of the organic EL element 11. A cathode electrode (not shown) of the organic EL element 11 is, for example, connected to a ground line GND. A back-gate electrode (not shown) of the drive transistor Tr₁ is connected to a back-gate line BGL. The cathode electrode, which is used as a common electrode of the organic EL elements 11, is, for example, continuously formed and thus has a plate-like shape over the whole of the display region of the display panel 10.

Drive Circuit

Next, circuits within the drive circuit 20 provided in the periphery of the pixel circuit array section 13 will be described with reference to FIG. 1.

A video signal processing circuit 21 performs predetermined correction on a digital video signal 20A inputted from the outside, and outputs a video signal 21A, which has been subjected to the correction, to a signal line drive circuit 23. The predetermined correction includes gamma correction, overdrive correction and the like.

A timing generator circuit 22 controls the signal line drive circuit 23, a write line drive circuit 24, and a back-gate line drive circuit 25 such that the circuits operate in conjunction with one another. The timing generator circuit 22, for example, outputs a control signal 22A to each of the circuits in response to (in synchronization with) a synchronizing signal 20B inputted from the outside.

The signal line drive circuit 23 applies an analog video signal corresponding to the video signal 21A to each signal line DTL in response to (in synchronization with) an inputted control signal 22A so that the analog video signal or a corresponding signal is written to a pixel circuit 14 as a selection object. Specifically, the signal line drive circuit 23 applies signal voltage V_{sig} corresponding to the video signal 21A to each signal line DTL for writing to the pixel circuit 14 as a selection object. Here, writing refers to applying a predetermined voltage to the top gate G1 of the drive transistor Tr₁.

For example, the signal line drive circuit 23 may output the signal voltage V_{sig} and voltage V_{ofs} to be applied to the top gate G1 of the drive transistor Tr₁ for stopping light emission of the organic EL element 11. The voltage V_{ofs} has a value (constant value) lower than a value of threshold voltage Vₑₗ of the organic EL element 11.

The write line drive circuit 24 sequentially applies a selection pulse to a plurality of write lines WSL in response to (in synchronization with) an inputted control signal 22A so that a plurality of organic EL elements 11 and a plurality of pixel circuits 14 are sequentially selected. For example, the write line drive circuit 24 may output voltage Vₒₙ applied for turning on the write transistor Tr₂ and voltage V_{off} applied for turning off the write transistor Tr₂.

The back-gate line drive circuit 25 sequentially applies a control pulse to a plurality of back-gate lines BGL in response to (in synchronization with) an inputted control signal 22A so that flow of current I_{d} into an organic EL element 11 as a selection object is switched on or off. For example, the back-gate line drive circuit 25 may output voltage V_{b1} (first voltage) applied for starting light emission of the organic EL element 11 and voltage V_{b2} (second voltage) applied for stopping light emission thereof. The voltage V_{b1} and the voltage V_{b2} have values different from each other. The voltage V_{b1} is, for example, 0 V (zero volts). The voltage V_{b2} is lower than the voltage V_{b1}, for example, −5.0 V, because the drive transistor Tr₁ is a p-channel transistor in the embodiment.

Operation of Display Device 1

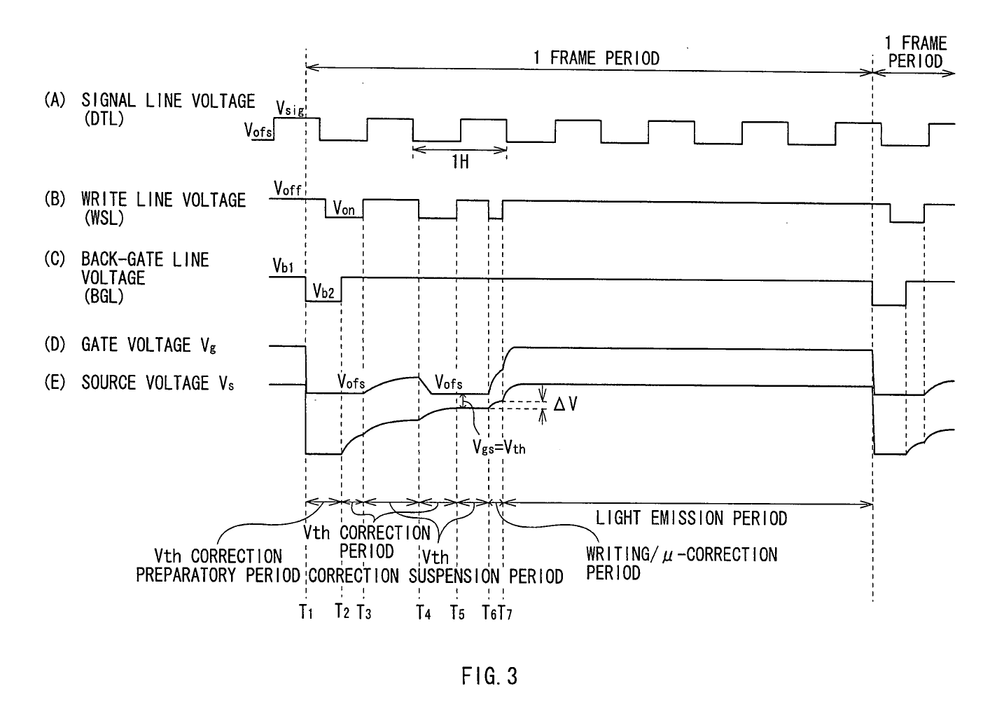

FIG. 3 shows an example of various waveforms when the display device 1 is driven. In FIG. 3, (A) and (B) show an aspect where the signal line DTL is periodically applied with voltages V_{sig} and V_{ofs}, and the write line WSL is applied with voltages Vₒₙ and V_{off} at a predetermined timing, respectively. (C) shows an aspect where the back-gate line BGL is applied with voltages V_{b1} and V_{b2} at a predetermined timing, illustrating a waveform in the case that the voltage V_{b2} is lower than the voltage V_{b1}, namely, the drive transistor Tr₁ is a p-channel transistor. (D) and (E) show an aspect where gate voltage V_{g} and source voltage Vₛ of the drive transistor Tr₁ are changed every moment in response to voltage application to each of the signal line DTL, the write line WSL and the back-gate line BGL.

Vₜₕ Correction (Threshold Value Correction) Preparatory Period

First, Vₜₕ correction is prepared. Specifically, the back-gate line drive circuit 25 changes voltage of the back-gate line BGL from V_{b1} to V_{b2} (T₁). Thus, the drive transistor Tr₁ is turned off, so that the organic EL element 11 stops emitting light. Then, the back-gate line drive circuit 25 keeps voltage of the back-gate line BGL to V_{b2} until threshold voltage correction of the drive transistor Tr₁ is started.

First Vₜₕ, Correction Period

Next, Vₜₕ correction is performed. Specifically, when voltage of the signal line DTL is V_{ofs}, and voltage of the write line WSL is Vₒₙ, the back-gate line drive circuit 25 changes voltage of the back-gate line BGL from V_{b2} to V_{b1} (T₂). Thus, current I_{d} flows between the drain and source of the drive transistor Tr₁, so that source voltage Vₛ is increased. Then, the write line drive circuit 24 changes voltage of the write line WSL from Vₒₙ to V_{off}, and then the signal line drive circuit 23 changes voltage of the signal line DTL from V_{ofs} to V_{sig} (T₃). Thus, the gate of the drive transistor Tr₁ turns into floating, so that Vₜₕ correction is suspended.

First Vₜₕ Correction Suspension Period

During suspension of Vₜₕ correction, sampling of voltage of the signal line DTL is performed in a row (pixel) different from a row (pixel) subjected to the previous Vₜₕ correction. When Vₜₕ correction is insufficient, namely, when potential difference V_{gs} between the gate and source of the drive transistor Tr₁ is larger than the threshold voltage Vₜₕ of the drive transistor Tr₁, the following occurs. That is, even during the Vₜₕ correction suspension period, current I_{d} flows between the drain and source of the drive transistor Tr₁ in the row (pixel) subjected to the previous Vₜₕ correction, and thus source voltage Vₛ is increased, and gate voltage V_{g} is also increased through coupling via the capacitance Cₛ.

Second Vₜₕ Correction Period

After the Vₜₕ correction suspension period has been finished, Vₜₕ correction is performed again. Specifically, when voltage of the signal line DTL is V_{ofs}, and Vₜₕ correction is enabled, the write line drive circuit 24 changes voltage of the write line WSL from V_{off} to Vₒₙ (T₄), so that the gate of the drive transistor Tr₁ is connected to the signal line DTL. At that time, when source voltage Vₛ is lower than (V_{ofs}-Vₜₕ) (Vₜₕ correction is still not completed), current I_{d} flows between the drain and source of the drive transistor Tr₁ until the transistor Tr₁ is cut off (until potential difference V_{gs} becomes equal to Vₜₕ). As a result, the capacitance Cₛ is charged to Vₜₕ, so that the potential difference V_{gs} becomes equal to Vₜₕ. Then, the write line drive circuit 24 changes voltage of the write line WSL from Vₒₙ to V_{off}, and then the signal line drive circuit 23 changes voltage of the signal line DTL from V_{ofs} to V_{sig} (T₅). Thus, the gate of the drive transistor Tr₁ turns into floating, and therefore the potential difference V_{gs} may be kept to Vₜₕ regardless of magnitude of voltage of the signal line DTL. In this way, the potential difference V_{gs} is set to Vₜₕ, thereby even if the threshold voltage Vₜₕ of the drive transistor Tr₁ varies for each pixel circuit 14, variation in emission luminance of the organic EL element 11 may be prevented.

Second Vₜₕ Correction Suspension Period

Then, the signal line drive circuit 23 changes voltage of the signal line DTL from V_{ofs} to V_{sig} in a second Vₜₕ-correction suspension period.

Writing and μ Correction Period

After the Vₜₕ correction suspension period has been finished, writing and μ correction are performed. Specifically, when voltage of the signal line DTL is V_{sig}, the write line drive circuit 24 changes voltage of the write line WSL from \T_{off} to Vₒₙ (T₆), so that the gate of the drive transistor Tr₁ is connected to the signal line DTL. Thus, gate voltage of the drive transistor Tr₁ becomes equal to V_{sig}. Anode voltage of the organic EL element 11 is still lower than threshold voltage Vₑₗ of the organic EL element 11 in this stage, and therefore the organic EL element 11 is cut off. Therefore, current I_{d} flows into element capacitance (not shown) of the organic EL element 11, so that the element capacitance is charged, resulting in increase in source voltage Vₛ by ΔV, and eventually voltage difference V_{gs} becomes equal to V_{sig}+Vₜₕ−ΔV. In this way, writing and μ correction are concurrently performed. Since ΔV is increased with increase in mobility μ of the drive transistor Tr₁, variation in mobility μ for each pixel circuit 14 may be removed by decreasing the voltage difference V_{gs} by ΔV before start of light emission.

Light Emission Period

Next, the write line drive circuit 24 changes voltage of the write line WSL from Vₒₙ to V_{off} (T₇). Thus, the gate of the drive transistor Tr₁ turns into floating, so that current I_{d} flows between the drain and source of the drive transistor Tr₁ while the voltage V_{gs} between the gate and source of the transistor Tr₁ is kept constant. As a result, source voltage Vs is increased, and accordingly gate potential of the drive transistor Tr₁ is increased, and consequently the organic EL element 11 starts to emit light with luminance lower than a desired luminance.

Then, when a predetermined time has passed, the back-gate line drive circuit 25 changes voltage of the back-gate line BGL from V_{b1} to V_{b2} (T₁) so that the organic EL element 11 stops emitting light. In this way, the drive circuit 20 operates such that light emission of the organic EL element 11 is repeatedly started and stopped.

Operation

In the display device 1 of the embodiment, on/off control of the pixel circuit 14 is performed for each pixel 12, and drive current is thus injected into an organic EL element 11 of the pixel 12 as above, thereby recombination of holes and electrons occurs, leading to light emission. Such emitted light is transmitted by electrodes and the like of the organic EL element 11 and then extracted to the outside. As a result, an image is displayed on the display panel 10.

Advantage

In an organic EL element in the past, for example, a pixel circuit has had a switching transistor between an organic EL element and TFT connected in series to the EL element in as a measure to control start or stop of light emission of an organic EL element. However, in such a case, high resolution has been hardly achieved since pixel size is increased in correspondence to such an added switching transistor.

In the embodiment, a dual-gate transistor is used as the drive transistor Tr₁, and a unique characteristic of the dual-gate transistor is used to overcome the above difficulty. The unique characteristic will be described below.

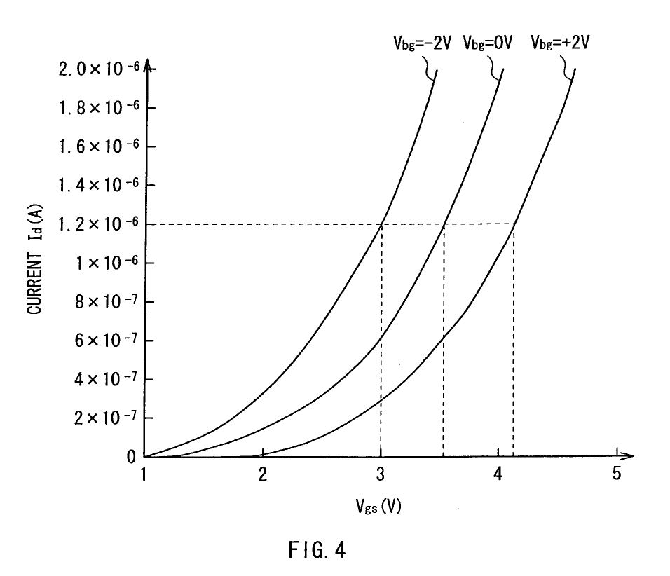

FIG. 4 shows an example of an I_{d}-V_{gs} characteristic in a saturated region of a dual-gate transistor in the case that voltage V_{bg} of the back gate G2 is set to 0 V, +2.0 V or −2.0 V. FIG. 4 illustrates an I_{d}-V_{gs} characteristic in the case that the transistor is a p-channel transistor. FIG. 4 reveals that in the case that the transistor is a p-channel transistor, when the voltage V_{bg} of the back gate G2 is changed, for example, from 0 V to +2.0 V, increase in I_{d} against increase in V_{gs} (inclination of the I_{d}-V_{gs} characteristic) is decreased. This means that when the voltage V_{bg} of the back gate G2 is changed in a positive direction with V_{gs} being constant, current I_{d} decreasingly flows into the transistor. Therefore, it is known that the voltage V_{bg} of the back gate G2 is changed from 0 V to a predetermined voltage value (for example, +5.0 V), thereby the transistor may be entirely turned off. Even when the transistor is an n-channel transistor, similar behavior is seen. In the case that the transistor is an n-channel transistor, for example, while not shown, when the voltage V_{bg} of the back gate G2 is changed from 0 V to −2.0 V, increase in I_{d} against increase in V_{gs} (inclination of the I_{d}-V_{gs} characteristic) is decreased. This means that when the voltage V_{bg} of the back-gate G2 is changed in a negative direction with V_{gs} being constant, current I_{d} decreasingly flows into the transistor. Therefore, in this case, it is known that the voltage V_{bg} of the back gate G2 is changed from 0 V to a predetermined voltage value (for example, −5.0 V), thereby the transistor may be entirely turned off.

In the embodiment, the unique characteristic is used to control on/off of the drive transistor Tr₁. Specifically, voltage of the back-gate line BGL is changed from V_{b1} to V_{b2}, thereby the drive transistor Tr₁ is turned off, and the organic EL element 11 accordingly stops emitting light. In addition, Vₜₕ correction, writing, and μ correction, are performed with the voltage of the back-gate line BGL being V_{b1}, and then voltage of the write line WSL is decreased from Vₒₙ to V_{off}, thereby the organic EL element 11 starts to emit light with a desired luminance.

In this way, in the embodiment, voltage applied to the back gate G2 of the drive transistor Tr₁ is controlled to turn on or off the transistor Tr₁, so that current flow into the organic EL element 11 is controlled. That is, the drive transistor Tr₁ is configured of a dual-gate transistor, and the voltage applied to the back gate G2 of the drive transistor Tr₁ is controlled, so that start or stop of light emission of a light emitting element may be controlled. Consequently, in the embodiment, start or stop of light emission of a light emitting element may be controlled without increasing the number of elements within the pixel circuit 14.

### Second Embodiment

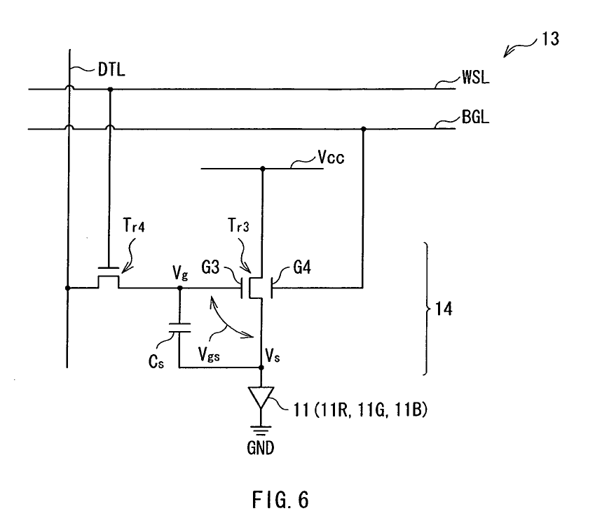

FIG. 5 shows a schematic configuration of a display device 2 according to a second embodiment of the invention. FIG. 6 shows a circuit configuration of a pixel circuit array section 13 of the display device 2 of FIG. 5. The display device 2 is different in configuration from the display device 1 of the first embodiment in that a drive circuit 20 has a back-gate line drive circuit 26 in place of the back-gate line drive circuit 25. Furthermore, the display device 2 is different in configuration from the display device 1 of the first embodiment in that a pixel circuit 14 has a drive transistor Tr₃ in place of the drive transistor Tr₁, and has a write transistor Tr₄ in place of the write transistor Tr₂. Hereinafter, a configuration of the display device 2 is described largely in points different from the configuration of the display device 1, and appropriately omitted to be described in points common to that of the display device 1.

The drive transistor Tr₃ is formed of a dual-gate transistor having a top gate G3 (first gate) and a back gate G4 (second gate), and besides formed of an n-channel MOS TFT. The write transistor Tr₄ is formed of, for example, a dual-gate, top-gate, or bottom-gate transistor, and besides formed of n-channel MOS TFT.

In the pixel circuit array section 13, each signal line DTL is connected to an output end (not shown) of a signal line drive circuit 23, and to a drain or source electrode (not shown) of the write transistor Tr₄. Each write line WSL is connected to an output end (not shown) of the write line drive circuit 24, and to a gate electrode (not shown) of the write transistor Tr₄. One of the drain and source electrodes of the write transistor Tr₄ (not shown), being not connected to the signal line DTL, is connected to a top gate electrode (not shown) of the drive transistor Tr₃ and to one end of capacitance Cₛ. A drain or source electrode (not shown) of the drive transistor Tr₃ and the other end of the capacitance Cₛ are connected to an anode electrode (not shown) of the organic EL element 11. One of the drain and source electrodes of the drive transistor Tr₃ (not shown), being not connected to the anode electrode of the organic EL element 11, is connected to the constant-voltage line Vcc. A cathode electrode (not shown) of the organic EL element 11 is, for example, connected to a ground line GND. A back gate electrode (not shown) of the drive transistor Tr₃ is connected to a back-gate line BGL.

The back-gate line drive circuit 26 sequentially applies a control pulse to a plurality of back-gate lines BGL in response to (in synchronization with) an inputted control signal 22A so that flow of current I_{d} into an organic EL element 11 as a selection object is switched on or off. For example, the back-gate line drive circuit 26 may output a voltage V_{b3} (first voltage) applied for starting light emission of the organic EL element 11 and a voltage V_{b4} (second voltage) applied for stopping light emission thereof. The voltage V_{b3} and the voltage V_{b4} have values different from each other. The voltage V_{b3} is, for example, 0 V (zero volts). The voltage V_{b4} is higher than the voltage V_{b3}, for example, +5.0 V, because the drive transistor Tr₃ is an n-channel transistor in the embodiment.

Operation of Display Device 2

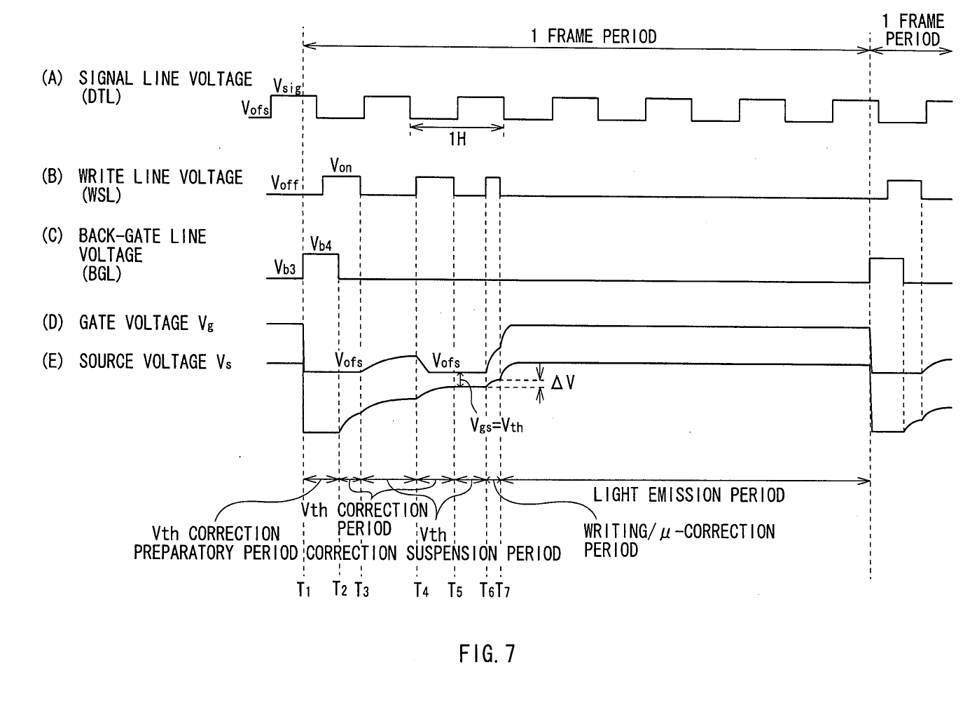

FIG. 7 shows an example of various waveforms when the display device 2 is driven. In FIG. 7, (A) and (B) show an aspect where the signal line DTL is periodically applied with voltages V_{sig} and V_{ofs}, and the write line WSL is applied with voltages Vₒₙ and V_{off} at a predetermined timing, respectively. (C) shows an aspect where the back-gate line BGL is applied with voltages V_{b3} and V_{b4} at a predetermined timing, illustrating a waveform in the case that the voltage V_{b4} is higher than the voltage V_{b3}, namely, the drive transistor Tr₃ is an n-channel transistor. (D) and (E) show an aspect where gate voltage V_{g} and source voltage Vₛ of the drive transistor Tr₃ are changed every moment in response to voltage application to each of the signal line DTL, the write line WSL and the back-gate line BGL.

Vₜₕ Correction Preparatory Period

First, Vₜₕ, correction is prepared. Specifically, the back-gate line drive circuit 26 changes voltage of the back-gate line BGL from V_{b3} to V_{b4} (T₁). Thus, the drive transistor Tr₃ is turned off, so that the organic EL element 11 stops emitting light. Then, the back-gate line drive circuit 26 keeps voltage of the back-gate line BGL to V_{b4} until threshold voltage correction of the drive transistor Tr₃ is started.

First Vₜₕ Correction Period

Next, Vₜₕ correction is performed. Specifically, when voltage of the signal line DTL is V_{ofs} and voltage of the write line WSL is Vₒₙ, the back-gate line drive circuit 26 changes voltage of the back-gate line BGL from V_{b4} to V_{b3} (T₂). Thus, current I_{d} flows between the drain and source of the drive transistor Tr₃, so that source voltage Vₛ is increased. Then, the write line drive circuit 24 decreases voltage of the write line WSL from Vₒₙ to V_{off}, and then the signal line drive circuit 23 changes voltage of the signal line DTL from V_{ofs} to V_{sig} (T₃). Thus, the gate of the drive transistor Tr₃ turns into floating, so that Vₜₕ correction is suspended.

First Vₜₕ Correction Suspension Period

During suspension of Vₜₕ correction, sampling of voltage of the signal line DTL is performed in a row (pixel) different from a row (pixel) subjected to the previous Vₜₕ correction. When Vₜₕ correction is insufficient, namely, when potential difference V_{gs} between the gate and source of the drive transistor Tr₃ is larger than the threshold voltage Vₜₕ of the drive transistor Tr₃, the following occurs. That is, even during the Vₜₕ correction suspension period, current I_{d} flows between the drain and source of the drive transistor Tr₃ in the row (pixel) subjected to the previous Vₜₕ correction, and thus source voltage Vₛ is increased, and gate voltage V_{g} is also increased through coupling via the capacitance Cₛ.

Second Vₜₕ Correction Period

After the Vₜₕ correction suspension period has been finished, Vₜₕ correction is performed again. Specifically, when voltage of the signal line DTL is V_{ofs}, and Vₜₕ correction is enabled, the write line drive circuit 24 increases voltage of the write line. WSL from V_{off} to Vₒₙ (T₄), so that the gate of the drive transistor Tr₃ is connected to the signal line DTL. At that time, when source voltage Vₛ is lower than (V_{ofs}-Vₜₕ) (Vₜₕ correction is still not completed), current I_{d} flows between the drain and source of the drive transistor Tr₃ until the transistor Tr₃ is cut off (until potential difference V_{gs} becomes equal to Vₜₕ). As a result, the capacitance Cₛ is charged to Vₜₕ, so that the potential difference V_{gs} becomes equal to Vₜₕ. Then, the write line drive circuit 24 decreases voltage of the write line WSL from Vₒₙ to V_{off}, and then the signal line drive circuit 23 changes voltage of the signal line DTL from V_{ofs} to V_{sig} (T₅). Thus, the gate of the drive transistor Tr₃ turns into floating, and therefore the potential difference V_{gs} may be kept to Vₜₕ regardless of magnitude of voltage of the signal line DTL. In this way, the potential difference V_{gs} is set to Vₜₕ, thereby even if the threshold voltage Vₜₕ of the drive transistor Tr₃ varies for each pixel circuit 14, variation in emission luminance of the organic EL element 11 may be prevented.

Second Vₜₕ Correction Suspension Period

Then, the signal line drive circuit 23 changes voltage of the signal line DTL from V_{ofs} to V_{sig} in a second Vₜₕ-correction suspension period.

Writing and μ Correction Period

After the Vₜₕ correction suspension period has been finished, writing and μ correction are performed. Specifically, when voltage of the signal line DTL is V_{sig}, the write line drive circuit 24 increases voltage of the write line WSL from V_{off} to Vₒₙ (T₆), so that the gate of the drive transistor Tr₃ is connected to the signal line DTL. Thus, gate voltage of the drive transistor Tr₃ becomes equal to V_{sig}. Anode voltage of the organic EL element 11 is still lower than threshold voltage Vₑₗ of the organic EL element 11 in this stage, and therefore the organic EL element 11 is cut off. Therefore, current I_{d} flows into element capacitance (not shown) of the organic EL element 11, so that the element capacitance is charged, resulting in increase in source voltage Vₛ by ΔV, and eventually voltage difference V_{gs} becomes equal to V_{sig}+Vₜₕ−ΔV. In this way, writing and μ correction are concurrently performed. Since ΔV is increased with increase in mobility μ of the drive transistor Tr₃, variation in mobility μ for each pixel circuit 14 may be removed by decreasing the voltage difference V_{gs} by ΔV before start of light emission.

Light Emission Period

Next, the write line drive circuit 24 decreases voltage of the write line WSL from Vₒₙ to V_{off} (T₇). Thus, the gate of the drive transistor Tr₃ turns into floating, so that current I_{d} flows between the drain and source of the drive transistor Tr₃ while the voltage V_{gs} between the gate and source of the drive transistor Tr₃ is kept constant. As a result, source voltage Vs is increased, and accordingly gate potential of the drive transistor Tr₃ is increased, and consequently the organic EL element 11 starts to emit light with luminance lower than a desired luminance.

Then, when a predetermined time has passed, the back-gate line drive circuit 26 changes voltage of the back-gate line BGL from V_{b3} to V_{b4} (T₁) so that the organic EL element 11 stops emitting light. In this way, the drive circuit 20 operates such that light emission of the organic EL element 11 is repeatedly started and stopped.

Operation

In the display device 2 of the embodiment, on/off control of the pixel circuit 14 is performed for each pixel 12, and drive current is thus injected into an organic EL element 11 of each pixel 12 as above, thereby recombination of holes and electrons occurs, leading to light emission. Such emitted light is transmitted by electrodes and the like of the organic EL element 11 and then extracted to the outside. As a result, an image is displayed on the display panel 10.

Advantage

In the embodiment, a dual-gate transistor is used as the drive transistor Tr₃, and the unique characteristic (described in the previous embodiment) of the dual-gate transistor is used to overcome the above difficulty. Specifically, voltage of the back-gate line BGL is changed from V_{b3} to V_{b4}, thereby the drive transistor Tr₃ is turned off, and the organic EL element 11 accordingly stops emitting light. In addition, Vₜₕ, correction, writing, and μ correction are performed with the voltage of the back-gate line BGL being V_{b3}, and then voltage of the write line WSL is decreased from Vₒₙ to V_{off}, thereby the organic EL element 11 starts to emit light with a desired luminance.

In this way, in the embodiment, voltage applied to the back gate G4 of the drive transistor Tr₃ is controlled to turn on or off the transistor Tr₃, so that current flowing into the EL element 11 is controlled. That is, the drive transistor Tr₃ is configured of a dual-gate transistor, and the voltage applied to the back gate G4 of the drive transistor Tr₃ is controlled, so that start or stop of light emission of a light emitting element may be controlled. Consequently, in the embodiment, start or stop of light emission of a light emitting element may be controlled without increasing the number of elements within the pixel circuit 14.

### Module and Application Examples

Hereinafter, application examples of the display device 1 or 2 described in the embodiment are described. The display device 1 or 2 according to the embodiment may be applied to a display device of each electronic device in any field, such as a television apparatus, a digital camera, a notebook personal computer, a mobile terminal such as mobile phone, or a video camera, for displaying an image or a video picture based on an externally-inputted or internally-generated video signal.

### Module

The display device 1 or 2 according to the embodiment may be built in various electronic devices such as application examples 1 to 5 described later, for example, in a form of a module shown in FIG. 8. In the module, for example, a region 210 exposed from a sealing substrate 32 is provided in one side of a substrate 31, and external connection terminals (not shown) are formed in the exposed region 210 by extending lines of the drive circuit 20. The external connection terminals may be attached with a flexible printed circuit (FPC) 220 for input or output of signals.

### Application Example 1

FIG. 9 shows appearance of a television apparatus using the display device 1 or 2 according to the embodiment. The television apparatus has, for example, an image display screen 300 including a front panel 310 and filter glass 320, and the image display screen 300 is configured of the display device 1 or 2 according to the embodiment.

### Application Example 2

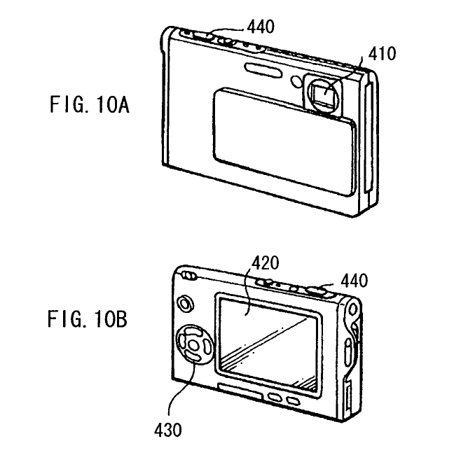

FIGS. 10A and 10B show appearance of a digital camera using the display device 1 or 2 according to the embodiment. The digital camera has, for example, a light emitting section for flash 410, a display 420, a menu switch 430 and a shutter button 440, and the display 420 is configured of the display device 1 or 2 according to the embodiment.

### Application Example 3

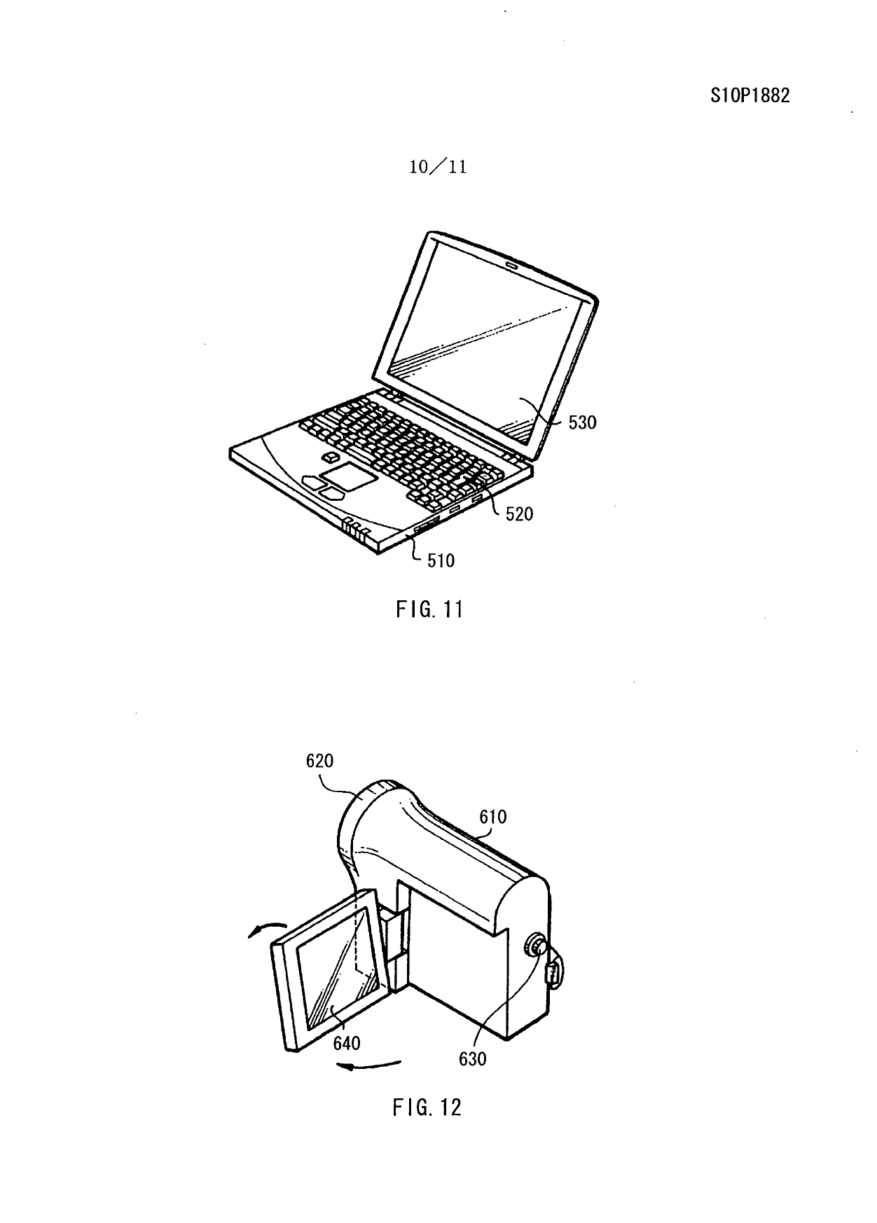

FIG. 11 shows appearance of a notebook personal computer using the display device 1 or 2 according to the embodiment. The notebook personal computer has, for example, a body 510, a keyboard 520 for input operation of letters and the like, and a display 530 for displaying images, and the display 530 is configured of the display device 1 or 2 according to the embodiment.

### Application Example 4

FIG. 12 shows appearance of a video camera using the display device 1 or 2 according to the embodiment. The video camera has, for example, a body 610, an object-shooting lens 620 provided on a front side-face of the body 610, and a start/stop switch 630 for shooting, and a display 640. The display 640 is configured of the display device 1 or 2 according to the embodiment.

### Application Example 5

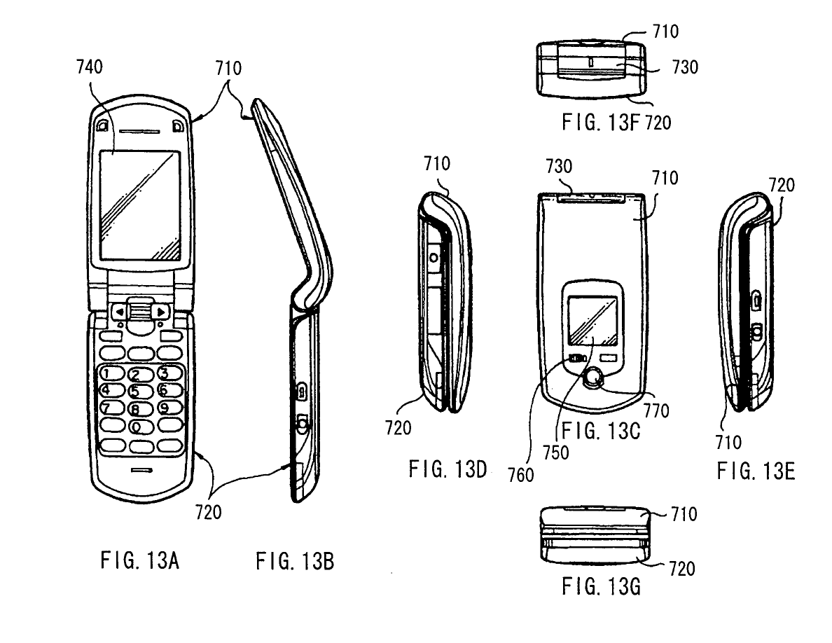

FIGS. 13A to 13G show appearance of a mobile phone using the display device 1 or 2 according to the embodiment. For example, the mobile phone is assembled by connecting an upper housing 710 to a lower housing 720 by a hinge 730, and has a display 740, a sub display 750, a picture light 760, and a camera 770. The display 740 or the sub display 750 is configured of the display device 1 or 2 according to the embodiment.

While the invention has been described with the embodiments and application examples hereinbefore, the invention is not limited to the embodiments and the like, and may be variously modified or altered.

For example, while the embodiments and the like have been described with a case where the display device 1 or 2 is an active-matrix display device, a configuration of the pixel circuit 14 for active matrix drive is not limited to those described in the embodiments and the like, and a capacitive element or a transistor may be added to the pixel circuit 14 as necessary. In such a case, a drive circuit to be necessary may be provided in addition to the signal line drive circuit 23, the write line drive circuit 24, and the back-gate line drive circuit 25 or 26 in accordance with change in pixel circuit 14.

Moreover, while the signal line drive circuit 23, the write line drive circuit 24, and the back-gate line drive circuit 25 or 26 are driven under control of the timing generator circuit 22 in the embodiments and the like, the drive circuits may be driven under control of another circuit. In addition, the signal line drive circuit 23, the write line drive circuit 24, and the back-gate line drive circuit 25 or 26 may be controlled by hardware (circuit) or software (program).

Moreover, while the pixel circuit 14 has a configuration of 2Tr1in the embodiments and the like, the pixel circuit 14 may have any configuration other than the configuration of 2Tr1as long as the configuration includes a dual gate transistor connected in series to the organic EL element 11.

Moreover, while the write transistor Tr₂ is a p-channel transistor in the first embodiment, the transistor Tr₂ may be an n-channel transistor. Furthermore, while the write transistor Tr₄ is an n-channel transistor in the second embodiment, the transistor Tr₄ may be a p-channel transistor.

The present application contains subject matter related to that disclosed in Japanese Priority Patent Application JP 2009-266734 filed in the Japan Patent Office on Nov. 24, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. A display device comprising:
a display section having sets of light emitting elements and pixel circuits arranged two-dimensionally; and
a drive section driving each of the pixel circuits based on a video signal,
wherein the pixel circuit has a dual-gate first transistor having a first gate and a second gate and controlling electric current flowing into each of the light emitting elements, and a second transistor writing a signal voltage into the first gate in accordance with the video signal, and
the drive section applies voltage to the second gate, the voltage being different between for starting light emission of the light emitting element and for stopping light emission of the light emitting element.

2. The display device according to claim 1,
wherein a drain or source of the first transistor is connected to the light emitting element, and
one of the drain and source of the first transistor, being not connected to the light emitting element, is connected to a constant voltage line.

3. The display device according to claim 1,
wherein when the first transistor is an n-channel transistor, the drive section applies a voltage to the second gate for starting light emission of the light emitting element, the voltage being higher than a voltage applied to the second gate for stopping light emission of the light emitting element.

4. The display device according to claim 1,
wherein when the first transistor is a p-channel transistor, the drive section applies a voltage to the second gate for starting light emission of the light emitting element, the voltage being lower than a voltage applied to the second gate for stopping light emission of the light emitting element.

5. A method of driving a display device comprising the steps of:
preparing a display device including a display section having sets of light emitting elements and pixel circuits arranged two-dimensionally, and a drive section driving each of the pixel circuits based on a video signal, wherein the pixel circuit has a dual-gate first transistor having a first gate and a second gate and controlling electric current flowing into each of the light emitting elements, and a second transistor writing a signal voltage into the first gate in accordance with the video signal; and
using the drive section to apply a first voltage to the second gate for stopping light emission of the light emitting element, and apply a second voltage to the second gate for starting light emission of the light emitting element, the second voltage being different in magnitude from the first voltage.

6. An electronic device comprising:
a display device,
wherein the display device includes
a display section having sets of light emitting elements and pixel circuits arranged two-dimensionally, and
a drive section driving each of the pixel circuits based on a video signal,
wherein the pixel circuit has a dual-gate first transistor having a first gate and a second gate and controlling electric current flowing into each of the light emitting elements, and a second transistor writing a signal voltage into the first gate in accordance with the video signal, and
the drive section applies voltage to the second gate, the voltage being different between for starting light emission of the light emitting element and for stopping light emission of the light emitting element.

7. A display device comprising:
a display section having sets of light emitting elements and pixel circuits arranged two-dimensionally,
wherein each of the pixel circuits has a dual-gate transistor having a first gate and a second gate and controlling electric current flowing into each of the light emitting elements,
the first gate is applied with a signal voltage in accordance with a video signal, and
the second gate is applied with voltage, the voltage being different between for starting light emission of the light emitting element and for stopping light emission of the light emitting element.
